(19) United States
(12) Patent Application Publication
(10) Pub. No.: US 2026/0185694 A1
(43) Pub. Date: Jul. 2, 2026

(54) INTELLIGENT LUMINOUS DATA CABLE

(71) Applicants: Shenzhen Yisheng Electric Co., Ltd., Shenzhen (CN); Shenzhen Rongda Xiucai Technology Co., Ltd., Shenzhen (CN)

(72) Inventors: LIANGHAI ZHANG, Shenzhen (CN); MINGFA GAO, Huaihua (CN)

(21) Appl. No.: 19/004,574

(22) Filed: Dec. 30, 2024

(51) Int. Cl. F21V 33/00; F21V 19/00; F21V 25/12; F21Y 103/10; F21Y 115/10

(52) U.S. Cl. CPC F21V 33/0052; F21V 19/003; F21V 25/12; F21Y 2103/10; F21Y 2115/10

(57) ABSTRACT

An intelligent luminous data cable is provided, which includes a connection mechanism configured to charge and discharge, and a control mechanism configured to control. The control mechanism includes a first charging head, which is provided with a main board. One end of the main board is welded with a connector of the connection mechanism, one end of the main board away from the connector is welded with a wire. The wire is wrapped around a wire body, and a luminous LED light strip for luminous is externally provided on the wire body. The luminous LED light strip is connected to the main board through a light-emitting lamp head. By physically controlling current transmission direction through an insurance component, a stable transfer of electricity from a discharging end to a charging end of a mobile phone can be ensured. A switch of the light-emitting lamp head can be manually controlled.

### TECHNICAL FIELD

The present disclosure relates to the field of data cable technologies, and in particular, to an intelligent luminous data cable.

### BACKGROUND

In digital time, various electronic devices such as smartphones, tablets, laptops, etc. have become indispensable tools in people's lives and work. As a key accessory for connecting these electronic devices with power supplies, computers, and other external devices for charging and data transmission, data cables have a very high frequency of use. Furthermore, in some special occasions such as outdoor camping or emergency situations at night that require the use of data cables, additional lighting equipment can increase the complexity and time cost of the operation. At the same time, traditional data cables have a single function, limited to power transmission and data transmission, and cannot meet people's demand for personalized and multifunctional products. In the modern consumer trend of pursuing a sense of technology and fashion, consumers expect the data cables to not only have basic practical functions, but also have some unique design elements to showcase personality and integrate with various usage scenarios. Based on the above needs and shortcomings, an intelligent luminous data cable has emerged. It integrates an intelligent lighting system on the basis of the traditional data cables, with touch sensing, gravity sensing, or light intensity sensing technologies to control the on and off of light sources and can present corresponding light indication effects according to different working states (such as charging, data transmission, etc.). It not only solves a problem of inconvenient use of data cables in dark environments, but also endows data cables with decorative and personalized features with the luminous effects, thus meeting the needs of modern consumers for convenient, practical, and fashionable electronic product accessories, which becomes an innovative product in the field of data cables.

In current luminous data cable devices, temporary charging is often required due to scene and operational limitations. However, the burden of carrying a power bank with one person is too great. But when one person's phone is fully charged and the other person's phone is out of power, it can also share the power with the data cable to solve urgent problems.

### SUMMARY

The purpose of the present disclosure is to provide an intelligent luminous data cable to solve the above-mentioned problems.

The present disclosure achieves the above objectives through the following technical solutions.

An intelligent luminous data cable, including a connection mechanism configured to charge and discharge, and a control mechanism configured to control; the control mechanism includes a first charging head, and the first charging head is internally provided with a main board; one end of the main board is welded with a connector of the connection mechanism, and one end of the main board away from the connector is welded with a wire; the wire is wrapped around a wire body, and the wire body is externally provided with a luminous LED light strip for luminous; the luminous LED light strip is connected to the main board through a light-emitting lamp head;
one side of the wire that is on the main board is provided with an insurance component; one end of the insurance component is electrically connected to a communication component, a control component, a reduction voltage component, a current regulation component, and a voice control component; power input terminals of the communication component, the control component, the reduction voltage component, and the voice control component are electrically connected to the connector; the main board is further provided with a control button and a state indicator light; one end of the wire body away from the first charging head is provided with a second charging head; the second charging head is further provided with the connector.

In some embodiments of the present disclosure, the control button and the state indicator light are electrically connected to the control component.

In some embodiments of the present disclosure, the insurance component is internally provided with a diode and a fuse, and a current direction is from the first charging head to the second charging head.

In some embodiments of the present disclosure, the connector on the second charging head is welded to the wire.

In some embodiments of the present disclosure, the connector is a type-c connector.

In some embodiments of the present disclosure, a rear of the main board is provided with heat dissipation fins.

In some embodiments of the present disclosure, a flame-retardant adhesive is filled between the main board and the first charging head.

Compared with existing technologies, the beneficial effects are as follows.

By physically controlling a current transmission direction through the insurance component, the stable transfer of electricity from a discharging end of a mobile phone to a charging end of the mobile phone can be ensured. The switch of the light-emitting lamp head can be manually controlled to avoid excessive power loss during use. At the same time, the use of the insurance component can prevent equipment damage caused by static electricity surges at a reverse end.

### BRIEF DESCRIPTION OF DRAWINGS

In order to provide a clearer explanation of the embodiments of the present disclosure or the technical solutions in the prior art, a brief introduction will be given to the accompanying drawings required for the description of the embodiments or the prior art. It is obvious that the accompanying drawings described below are only some embodiments of the present disclosure. For those skilled in the art, other drawings can be obtained based on these drawings without requiring creative work.

FIG. 1 is a schematic structural diagram of an intelligent luminous data cable according to the present disclosure.

FIG. 2 is a schematic structural diagram of a first charging head of the intelligent luminous data cable according to the present disclosure.

FIG. 3 is a schematic structural diagram of a main board of the intelligent luminous data cable according to the present disclosure.

FIG. 4 is a schematic structural diagram of an insurance component of the intelligent luminous data cable according to the present disclosure.

FIG. 5 is a schematic diagram of an internal structure of a first charging head of the intelligent luminous data cable according to the present disclosure.

Numeral reference: 1—first charging head; 2—wire body; 3—second charging head; 4—control button; 5—state indicator light; 6—light-emitting lamp head; 7—connector; 8—main board; 9—wire; 10—insurance component; 11—communication component; 12—control component; 13—reduction voltage component; 21—luminous LED light strip.

### DESCRIPTION OF EMBODIMENTS

In the description of the present disclosure, it should be noted that unless otherwise specified and limited, terms “installation”, “connection to”, and “connection with” should be broadly understood, for example, it can be a fixed connection, a detachable connection, or an integral connection; it can be a mechanical connection or an electrical connection; it can be directly connected, indirectly connected through an intermediate medium, or connected internally between two components. For those skilled in the art, the specific meanings of the above terms in the present disclosure can be understood through specific situations.

The present disclosure will be further explained in combination with the accompanying drawings

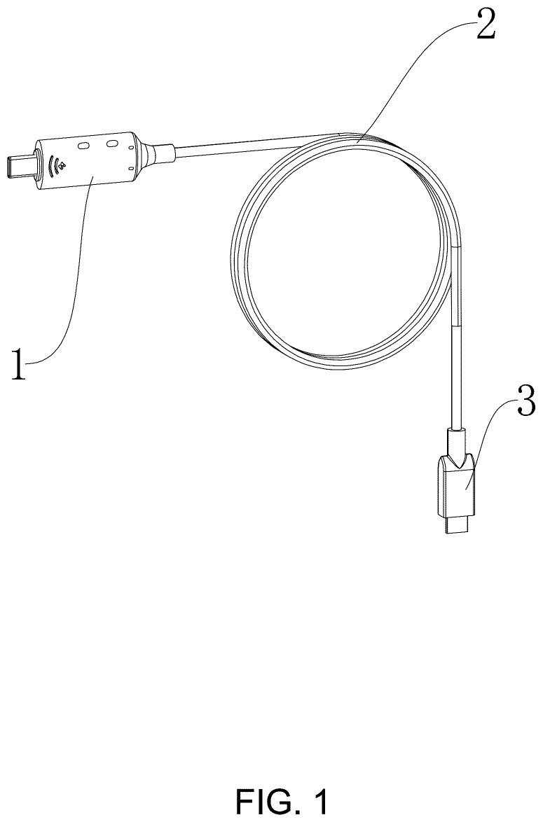

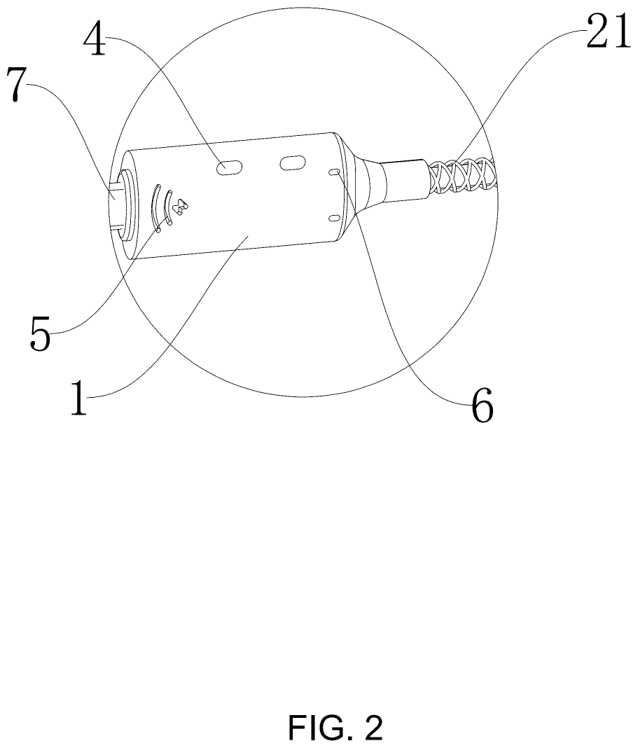

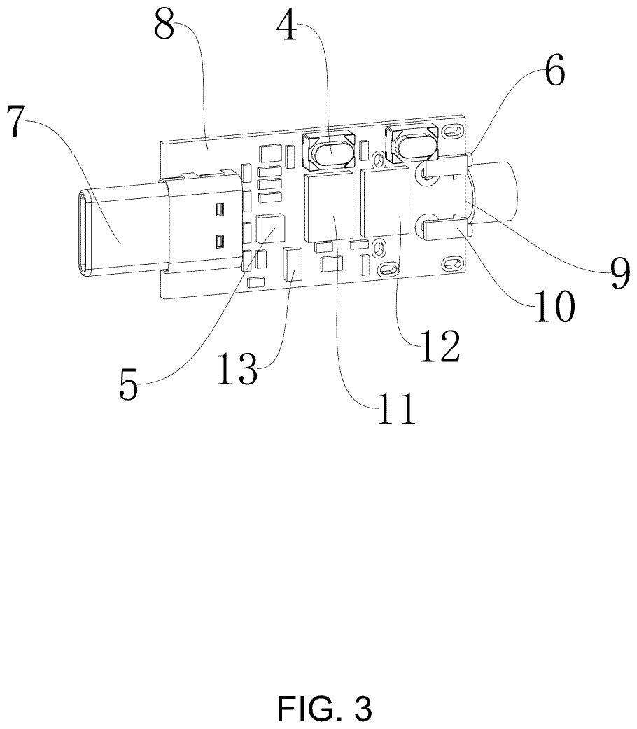

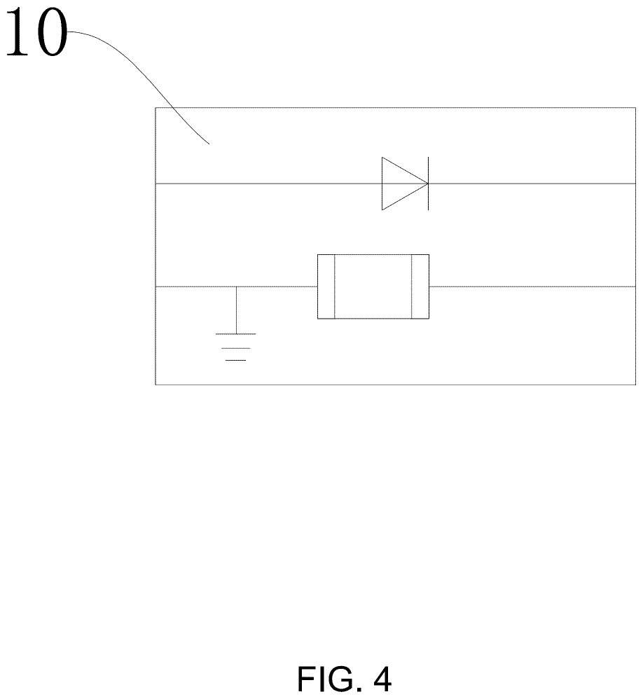

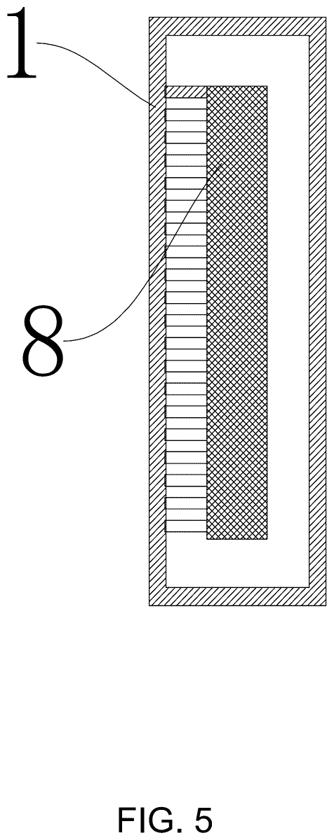

As shown in FIGS. 1-6, an intelligent luminous data cable includes a connection mechanism configured to charge and discharge, and a control mechanism configured to control. The control mechanism includes a first charging head 1, and the first charging head 1 is internally provided with a main board 8. One end of the main board 8 is welded with a connector 7 of the connection mechanism, and one end of the main board 8 away from the connector 7 is welded with a wire 9. The wire 9 is wrapped around a wire body 2, and the wire body 2 is externally provided with a luminous LED light strip 21 for luminous. The luminous LED light strip 21 is connected to the main board 8 through a light-emitting lamp head 6.

One side of the main board 8 that is on the wire 9 is provided with an insurance component 10. One end of the insurance component 10 is electrically connected to a communication component 11, a control component 12, a reduction voltage component 13, a current regulation component, and a voice control component. Power input terminals of the communication component 11, the control component 12, the reduction voltage component 13, and the voice control component are electrically connected to the connector 7. The main board 8 is further provided with a control button 4 and a state indicator light 5. One end of the wire body 2 far away from the first charging head 1 is provided with a second charging head 3. The second charging head 3 is further provided with the connector 7.

In this embodiment, the control button 4 and the state indicator light 5 are electrically connected to the control component 12.

In this embodiment, the insurance component 10 is provided with a diode and a fuse inside, and a current direction is from the first charging head 1 to the second charging head 3.

In this embodiment, the connector 7 on the second charging head 3 is welded to the wire 9.

In this embodiment, the connector 7 is a type-c connector.

In this embodiment, a rear of the main board 8 is provided with heat dissipation fins.

In this embodiment, a flame-retardant adhesive is filled between the main board 8 and the first charging head 1.

Working principle: according to a required operation mode, an expansion connector is selected to install on, or a charger is directly connected to the connector 7 at one end of the first charging head 1. In a charging mode through the charging head, the light-emitting head 6 is in a default mode, and can be connected to a mobile app through a blue tooth chip in the communication component 11 to control its mode. The lighting mode can also be controlled through the voice control component on the main board 8, namely a microphone (including color adjustment, brightness adjustment, and lighting marquee form control). The mobile app can more intuitively control color, brightness, and other ways through an interface. In this embodiment, there are also various types of control buttons, such as touch buttons and physical buttons, to achieve touch button control, or a physical button control; this embodiment can also be controlled through voice control using the mobile app and a hardware microphone (commonly known as voice control for internal and external control). After receiving sound through the microphone on the main board 8, the brightness and mode of the light can be controlled through the voice control component, or the mode of the light can be controlled through the mobile microphone in the mobile app.

Or when using one mobile terminal to charge another mobile terminal, the light emitting lamp head 6 is turned off by default. The current regulation component on the main board 8 is configured to control the boost or buck of its current, thereby ensuring the current of the charging end. Also, due to the insurance component 10, the internal diode ensures a unidirectional transmission of current, thus avoiding a phenomenon of reverse charging.

The above displays and describes the basic principles, main features, and advantages of the present disclosure. Those skilled in the art should understand that the present disclosure is not limited by the above embodiments. The above embodiments and the description in the specification only illustrate the principles of the present disclosure. Without departing from the spirit and scope of the present disclosure, the present disclosure may make various changes and improvements, all of which fall within the scope of the present disclosure.

1. An intelligent luminous data cable comprising:
a first charging head having a hollow internal cavity;
a main board fixed within the internal cavity of the first charging head;
a connector electrically connected to the main board and exposed outside the first charging head;
a wire electrically connected to the main board and extending outward from the first charging head;
a flexible wire body covering the wire;
an LED light strip arranged along an outer surface of the flexible wire body;
a light-emitting lamp head electrically connecting the LED light strip to the main board;
an insurance component disposed on the main board and electrically connected between the connector and the main board;
a communication component disposed on the main board and electrically connected to the connector;
a control component disposed on the main board and configured to control illumination of the LED light strip;
a control button and a status indicator disposed on the first charging head and electrically connected to the control component; and
a second charging head disposed at an opposite end of the wire body;
wherein the LED light strip is configured to emit light in response to charging current.

2. The intelligent luminous data cable according to claim 1, wherein the control button and the state indicator light are electrically connected to the control component.

3. The intelligent luminous data cable according to claim 1, wherein the insurance component is internally provided with a diode and a fuse, and a current direction is from the first charging head to the second charging head.

4. The intelligent luminous data cable according to claim 1, wherein the connector on the second charging head is welded to the wire.

5. The intelligent luminous data cable according to claim 1, wherein the connector is a type-c connector.

6. The intelligent luminous data cable according to claim 1, wherein a rear of the main board is provided with heat dissipation fins.

7. The intelligent luminous data cable according to claim 6, wherein a flame-retardant adhesive is filled between the main board and the first charging head.
